(19) United States
(12) Patent Application Publication
(10) Pub. No.: US 2013/0086087 A1
(43) Pub. Date: Apr. 4, 2013

(54) APPARATUS AND METHOD FOR GENERATING AND RETRIEVING LOCATION-TAGGED CONTENT IN COMPUTING DEVICE

(71) Applicants: Chan-Hee JUNG, Anyang-si (KR); Sang-Woong HWANG, Yongin-si (KR); Joon-Hwan KIM, Yongin-si (KR)

(72) Inventors: Chan-Hee JUNG, Anyang-si (KR); Sang-Woong HWANG, Yongin-si (KR); Joon-Hwan KIM, Yongin-si (KR)

(73) Assignee: Samsung Electronics Co., Ltd., Suwon-si (KR)

(21) Appl. No.: 13/445,421

(22) Filed: Apr. 12, 2012

(30) Foreign Application Priority Data
Sep. 29, 2011 (KR) 10-2011-0098784

(51) Int. Cl. G06F 17/30

(52) U.S. Cl. 707/752; 707/736; 707/754; 707/E17.059; 707/E17.005

(57) ABSTRACT

An apparatus and a method for generating and retrieving content in a computing device by operating a computing device, determining a location of the computing device and a place mark corresponding to the location is tagged to content.

### PRIORITY

The present application claims priority under 35 U.S.C. §119(a) to a Korean patent application, which was filed in the Korean Intellectual Property Office on Sep. 29, 2011, and assigned Serial No. 10-2011-0098784, the entire disclosure of which is incorporated herein by reference.

### BACKGROUND OF THE INVENTION

1. Field of the Invention

The present invention relates generally to an apparatus and a method for generating and retrieving content in a computing device.

2. Description of the Related Art

Recent developments in mobile devices such as smart phones and digital cameras, provide location information functionality when generating an image. However, a demand for obtaining location information does not only exist for generating an image. Location information may be useful for various other reasons depending on an individual interest such consumer interest of local information of a captured image. Therefore, to meet diversified demands of users, there is a need for adding location information to various content and retrieving content using the location information.

### SUMMARY OF THE INVENTION

Accordingly, the present invention has been made to solve at least the above-described problems and/or disadvantages and to provide at least the advantages below. Accordingly, an aspect of the present invention is to provide an apparatus and a method for incorporating location information into content when generating the content in a computing device.

Another aspect of the present invention is to provide an apparatus and a method for retrieving content using location information in a computing device.

Yet another aspect of the present invention is to provide an apparatus and a method for sorting content using location information in a computing device.

According to an aspect of the present invention, a method for operating a computing device is provided. The method includes determining a location of the computing device, and tagging a place mark to content corresponding to the location.

According to another aspect of the present invention, a method for operating a computing device is provided. The method includes displaying a list of content tagged with a first place mark among content registered in a database, requesting sharing of content selected by a user in the list of content, and receiving the content from the database.

According to still another aspect of the present invention, a method for operating a database is provided. The method includes providing a list of content tagged with a first place mark to a first user, receiving a request to share content in the list of content, and providing the content to the first user.

According to yet another aspect of the present invention, a computing device is provided. The computing device includes a location estimator for determining a location of the computing device, and a controller for tagging a place mark corresponding to the location to content.

According to another aspect of the present invention, a computing device is provided. The computing device includes a display unit for displaying a list of content tagged with a first place mark among content registered in a database, a controller for requesting sharing of content selected by a user in the list of content, and a communication unit for receiving the content from the database.

According to further still another aspect of the present invention, a database unit is provided. The database unit includes a controller for providing a list of content tagged with a first place mark to a first user, and a communication unit for receiving a request to share content in the list of content and providing the content to the first user.

According to further yet another aspect of the present invention, a method for operating a computing device is provided. The method includes determining a location of the computing device using a Global Positioning System (GPS), transmitting the location to a database, receiving a place mark corresponding to the location from the database, and tagging at least one of a place mark corresponding to the location, the location, a time, and weather information to content.

According to further yet still another aspect of the present invention, a method for operating a computing device is provided. The method includes requesting a database to transmit a list of content tagged with a first place mark, receiving the list of content from the database, displaying the list of content, requesting the database to transmit content selected by a user in the list of content, and receiving the content from the database.

According to further yet still another aspect of the present invention, a method for operating a database is provided. The method includes receiving a retrieve request of content tagged with a first place mark from a first user, retrieving content tagged with the first place mark among content registered by a user, providing a list of content tagged with the first place mark to the first user, receiving a request to share content in the list of content, and providing the content to the first user.

### BRIEF DESCRIPTION OF THE DRAWINGS

The above and other aspects, features and advantages of the present invention will be more apparent from the following description taken in conjunction with the accompanying drawings, in which:

FIG. 1 is a diagram illustrating a system according to an embodiment of the present invention;

FIG. 2 is a diagram illustrating an example of additional information tagged to content according to an embodiment of the present invention;

FIGS. 3A to 3C are diagrams illustrating tagging of a place mark according to an embodiment of the present invention;

FIGS. 4A and 4B are diagrams illustrating a tagging method according to an embodiment of the present invention;

FIGS. 5A to 5C are diagrams illustrating content retrieving using a place mark according to an embodiment of the present invention;

FIG. 6 is a flowchart illustrating a procedure for registering content of a computing device according to an embodiment of the present invention;

FIG. 7 is a flowchart illustrating a procedure for retrieving content of a computing device according to an embodiment of the present invention;

FIG. 8 is a flowchart illustrating a procedure for operating a database according to an embodiment of the present invention;

FIG. 9 is a block diagram illustrating a computing device according to an embodiment of the present invention; and

FIG. 10 is a block diagram illustrating a database according to an embodiment of the present invention.

### DETAILED DESCRIPTION OF EMBODIMENTS OF THE PRESENT INVENTION

Various embodiments of the present invention are described in detail with reference to the accompanying drawings. Detailed description of known functions or constructions are omitted to avoid obscuring the subject matter of the present invention.

The present invention relates to an apparatus and a method for generating and retrieving location-tagged content in a computing device by incorporating location information into content when generating the content in a computing device and retrieving the content using the location information. In the following description, the computing device includes a cellular phone, a Personal Communication System (PCS), a Personal Digital Assistant (PDA), an International Mobile Telecommunication (IMT)-2000 terminal, a smart phone, a tablet Personal Computer (PC), a lap-top computer, a desk-top computer, etc.

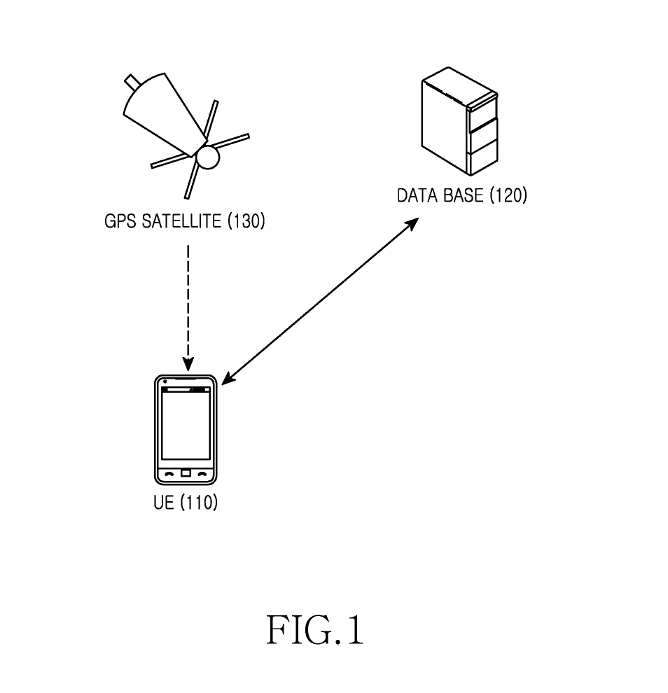

FIG. 1 is a diagram illustrating a system according to an embodiment of the present invention.

Referring to FIG. 1, User Equipment (UE) 110 is a computing device used by a user. The UE 110 accesses a core network via a mobile communication system, a commercial Internet cable system, and the like. For example, the core network may be an Internet network. The UE 110 provides a location information generating function, a personal information sort function, and an information and content sharing function. For the location information generating function, the UE 110 may have a capability of estimating a location using a signal of a Global Positioning System (GPS) satellite 130, or have capability of estimating a location using signals of base stations of a mobile communication system. A database 120 stores content generated by the UE 110 and other UEs, and provides a service of retrieving stored content to the UE 110 and the other UEs. That is, the UE 110 may store generated content in the database 120, and the UE 110 and the other UEs may share content stored in the database 120. A coupon, points, etc. may be provided as a reward to the UE 110 that has provided the content. The database 120 may be a cloud server.

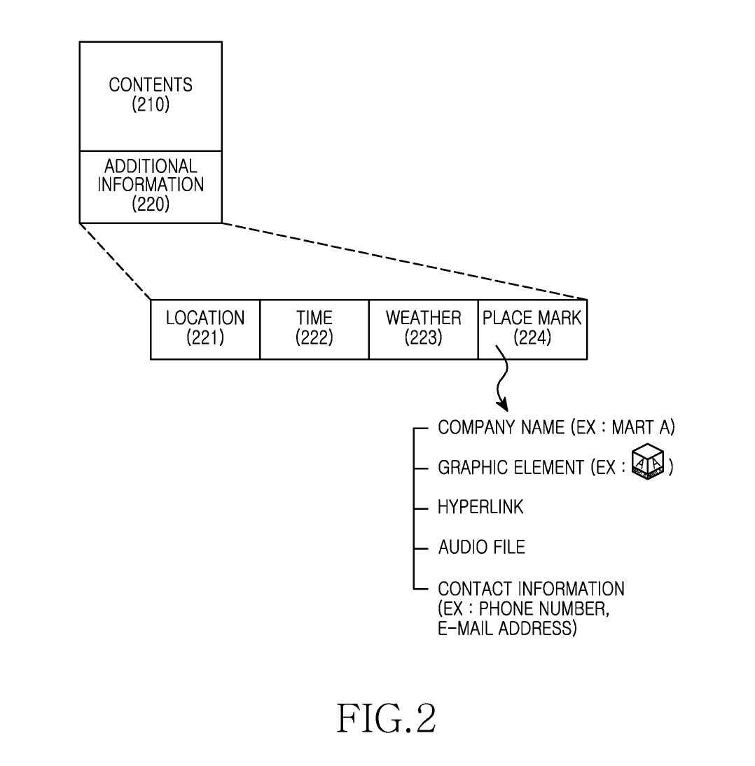

The UE 110 generates content according to user interaction. For example, the content may be generated by shopping, audio recording, image or moving picture capturing, etc. In addition, the UE 110 tags additional information to the content. The tagging of the additional information may be performed not only right after content has been generated but also on previously generated content and on content input from the outside. The tagging may be performed automatically without intervention of a user, or manually according to user selection. An example of the additional information is illustrated in FIG. 2.

FIG. 2 is a diagram illustrating an example of additional information tagged to content according to an embodiment of the present invention. Referring to FIG. 2, additional information is tagged to content 210. The additional information 220 may include not only a location 221, a time 222, but also at least one of weather 223 and a place mark 224 sorted based on a location. The weather 223 may be weather information (for example, fine, cloudy, rainy, snowy, etc.) of a point at which the content 210 are generated, or weather information of a point at which the content 210 are downloaded. The place mark 224 represents a specific place (for example, a store, etc.) located in the neighborhood of the UE 110 at a point at which the content 210 are generated. The place mark 224 has a form of a company name or a graphic element. The graphic element may be denoted by a Graphic User Interface (GUI) element. In addition, the place mark 224 may be defined in various forms besides the company name or the graphic element. For example, the place mark 224 may have a form of a hyperlink, an audio, contact information (for example, a phone number and an email address), and the like.

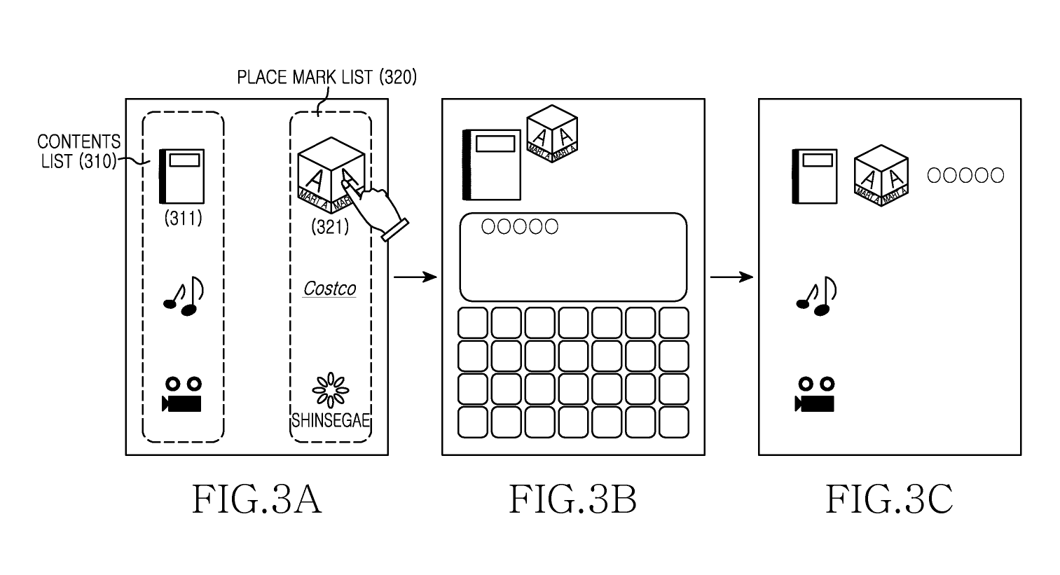

The database 120 stores and manages a plurality of place marks, and provides a place mark depending on the location of the UE 110. A company of a relevant place may store the place mark 224 in the database 120 by registering the place mark 224 in the database 120 in advance. For example, the UE 110 transmits location information to the database 120, and the database 120 provides a place mark corresponding to the location of the UE 110 to the UE 110. For another example, the UE 110 extracts identification information (for example, a company name, an address, a location, etc.) of places in the neighborhood of a current location from a stored electronic map, transmits the extracted information of the places to the database 120, and the database 120 may provide place marks corresponding to the information of the places. However, where the UE 110 stores a mark to display in advance, the UE 110 may not receive a place mark from the database 120. Accordingly, the UE 110 may display a place mark via a display unit such as a screen, and the like, and tags a place mark selected by a user to relevant content. For example, the tagging of the place mark may be performed as in FIG. 3.

FIGS. 3A to 3C are diagrams illustrating tagging of a place mark according to an embodiment of the present invention. As illustrated in FIG. 3A, the UE 110 displays a content list 310 stored in the UE 110 and a place mark list 320 provided from the database 120. The content list 310 may include at least one of content generated by the UE 110 and content input from the outside. Though not shown in FIG. 3A, the place mark list 320 may be sorted and displayed for each business field, each category, and each distance from the UE 110.

Place marks included in the place mark list 320 may be a portion of place marks corresponding to a current location of the UE 110. For example, where the UE desires to display a portion of the place marks due to an excessively large number of place marks corresponding to the current location of the UE 110, the database 120 may provide only a portion of place marks via filtering, or the UE 110 may receive all place marks and then display only a filtered portion of place marks. Filtering may be performed according to various standards. For example, the database 120 or the UE 110 may perform filtering to display place marks belonging to a category selected in advance. The category may be defined based on classification (for example, restaurant, coffee shop, fitness center, bookstore, flower shop, etc.) depending on handled goods/service, classification (for example, building, street, bridge, etc.) depending on a structure type of a relevant place, and the like. For another example, the database 120 or the UE 110 may perform filtering depending on a distance from the current location of the UE 110. For another example, the database 120 or the UE 110 may perform filtering to display place marks recently used, or to display place marks registered as favorite.

After the place mark list 320 is displayed, a user selects one graphic element 321 and drags and drops the graphic element 321 onto a memo 311. In other words, the user inputs a command meaning tagging the graphic element 321 to the memo 311. Accordingly, as illustrated in FIG. 3B, the UE tags the graphic element 321 to the memo 311, and displays an interface for inputting an additional comment. Accordingly, the user inputs additional information.

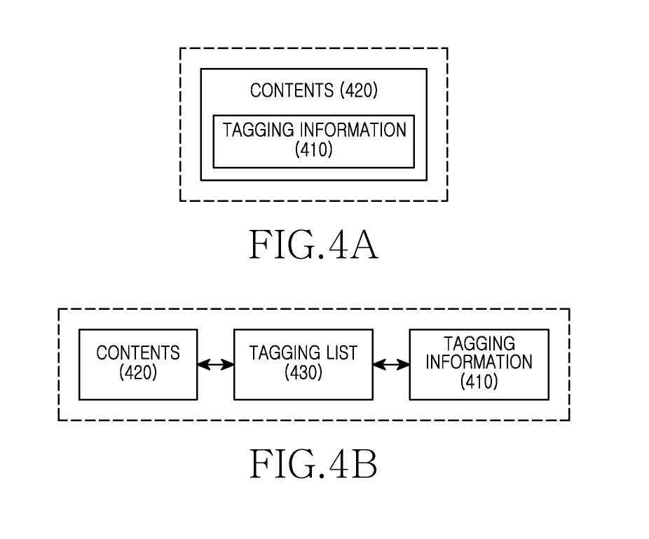

Tagging may be performed in various methods. FIGS. 4A and 4B are diagrams illustrating a tagging method according to an embodiment of the present invention. For example, as illustrated in FIG. 4A, tagging information 410 (for example, a graphic element 321, a comment, etc.) may be stored inside content 420 (for example, a memo 311). The tagging information 410 and the content 420 configure one unit data (for example, a file). As another example, as illustrated in FIG. 4B, the tagging information 410 may be stored separately from the content 420, and a tagging list 430 representing a mapping relation between the tagging information 410 and the content 420 may be generated.

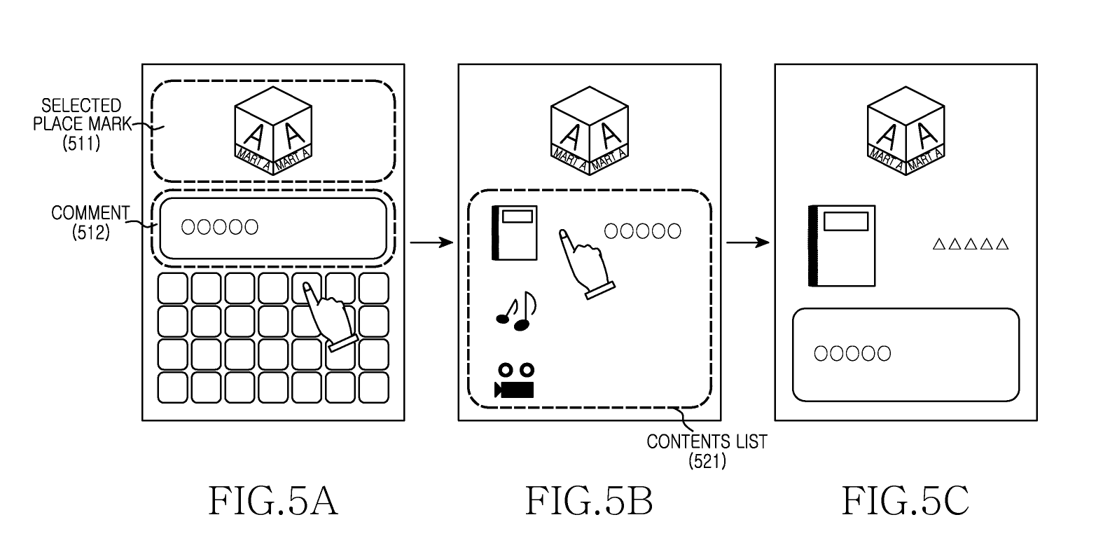

After, as illustrated in FIG. 3C, the UE 110 may tag a place mark and an input comment as additional information. The comment may be utilized as a retrieve keyword and a retrieve trigger during a content retrieve operation, or may be utilized as description information for content. The comment input process may be omitted. The place mark may be used for retrieving content. Content retrieving using the place mark may be performed as illustrated in FIG. 5.

FIGS. 5A to 5C are diagrams illustrating content retrieving using a place mark according to an embodiment of the present invention. As illustrated in FIG. 5A, a user selects a place mark 511 representing a specific place and inputs a comment 512 in order to retrieve content related to the specific place. Though FIG. 5A illustrates a circumstance where both the place mark 511 and the comment 512 have been input as a retrieve trigger, only one of the place mark 511 and the comment 512 may be input. In addition, where an audio type place mark 511 is tagged, the UE 110 may provide a retrieve service via voice recognition. Accordingly, the UE 110 transmits at least one of the place mark 511 and the comment 512 to the database 120 together with a content retrieve request.

When a content list related to the place mark 511 and the comment 512 is provided from the database 120 among stored content, as illustrated in FIG. 5B, the UE 110 displays the content list 521. In displaying the content list 521, according to an embodiment of the present invention, content included in the content list 521 may be a portion of all content corresponding to a retrieve trigger. For example, where the UE 110 desires to display a portion of the content due to an excessive large number of content corresponding to the retrieve trigger, the database 120 may provide content via filtering, or the UE 110 may receive all content and then display a filtered portion of content. The filtering may be performed according to various standards. For example, the database 120 or the UE 110 may perform filtering to display content belonging to a category selected in advance. The category may be defined based on classification (for example, restaurant, coffee shop, fitness center, bookstore, flower shop, etc.) depending on handled goods/service, classification (for example, building, street, bridge, etc.) depending on a structure type of a relevant place, etc. For another example, the database 120 or the UE 110 may perform filtering depending on a distance from the current location of the UE 110. For another example, the database 120 or the UE 110 may perform filtering to display recently used content, or to display content registered as favorite, or to display content stored in a folder directly generated by a relevant user.

As illustrated in FIG. 5C, the UE 110 requests the database 120 to transmit content selected by a user, receives the content, and then displays content of the content. At this point, charging for content use may be performed. In case of FIG. 5, a memo has been selected and content of the memo have been displayed. Where a moving image, an image, audio, etc. are selected, the UE 110 may reproduce relevant content.

As described with reference to FIGS. 5A to 5C, content of selected content is displayed or a different operation may be performed depending on a specific form of a place mark. For example, where the selected content is tagged with a place mark of a hyperlink form, the UE 110 may share a web page indicated by the hyperlink. For another example, where the selected content is tagged with a place mark of an audio form, the UE 110 may reproduce the audio. For another example, where the selected content is tagged with a place mark of a contact information form, the UE 110 may display an interface for writing a mail or a character to the contact information, or may try a telephone connection to the contact information.

Hereinafter, the operation and construction of a computing device for tagging and retrieving content and a database according to the embodiment of the present invention is described with reference to the drawings.

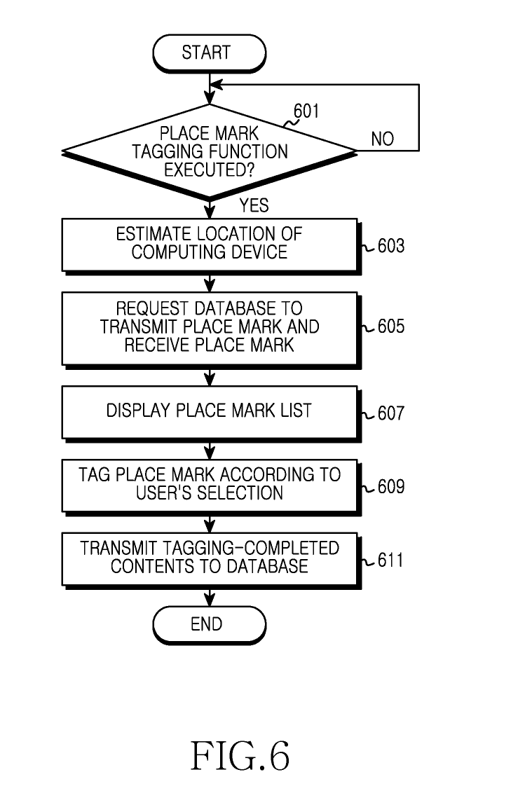

FIG. 6 is a flowchart illustrating a procedure for registering content of a computing device according to an embodiment of the present invention.

Referring to FIG. 6, the computing device determines whether a place mark tagging function is executed in Step 601. For example, the place mark tagging function may be executed by user command. Specifically, the user may input a command indicating place mark tagging for stored content to the computing device. The content tagged with the place mark may be selected when a command is input, or may be selected during a tagging procedure described below. For another example, the place mark tagging function may be executed without a separate command after generation of content.

When the place mark tagging function is executed, the computing device proceeds to Step 603 to estimate a current location of the computing device. For example, the location may be estimated using signals of a GPS satellite, or may be estimated via a Time Of Arrival (TOA) technique, a Time Difference Of Arrival (TDOA) technique, etc. that uses signals of base stations of a mobile communication system.

The computing device proceeds to Step 605 to request a database to transmit a place mark, and receives a place mark. For example, the computing device may transmit the location information estimated in Step 603 to the database, and receive a place mark corresponding to the estimated location. For another example, the computing device may extract information (for example, a company name, an address, a location, etc.) of places in the neighborhood of the location estimated in Step 603 from a stored electronic map, transmit the extracted information of the places to the database, and receive place marks corresponding to the information of the places. Where the computing device stores all of place marks to display in advance, Step 605 may be omitted.

After obtaining the place mark, the computing device proceeds to Step 607 to display a place mark list including a place mark. The place mark includes at least one of a company name and a graphic element. The computing device may sort the place mark according to at least one of a business field, a category, a distance from the computing device, and display the same. The computing device may filter a portion of the obtained place marks, and then display the filtered portion. For example, the filtering may be performed to display a place mark belonging to a category selected in advance, display a place mark of a place existing within a predetermined distance from the computing device, display place marks recently used, or display place marks registered as favorite. A place mark that has passed through the filtering may be received in Step 605.

After displaying the place mark list, the computing device proceeds to Step 609 to tag a place mark to content depending on user selection. Where content has been already selected during execution of the place mark tagging function, the computing device tags a selected place mark to the content. Where content is selected together with the place mark, the computing device tags the selected place mark to the content. In addition to tagging of the place mark, though not shown in FIG. 6, the computing device may receive a comment for the content. That is, the computing device may display an interface for inputting the comment, and further tag a comment input by a user to the content. In addition, though not shown in FIG. 6, the computing device may further tag information of a location, a time, weather, etc. estimated in Step 603. The location, the time, the weather, etc. may be tagged via a separate procedure besides the procedure illustrated in FIG. 6. To tag the place mark, the computing device may store the place mark inside the content, or store the place mark separately from the content, and generate a tagging list representing a mapping relation between the place mark and the content.

The computing device proceeds to Step 611 to transmit tagging-completed content to the database. The computing device may transmit together information regarding a sharing right of the content according to user command or user setting. For example, the information regarding the sharing right may include content of allowing only a specific user or other users classified to a specific group to share content, or not allowing sharing. In addition, the computing device may transmit identification information of the computing device or the user together. In addition, though not shown in FIG. 6, a user of the computing device may receive a coupon, points, etc. in reward for providing the content. The computing device may receive information informing the provided reward, and display the same via a display unit.

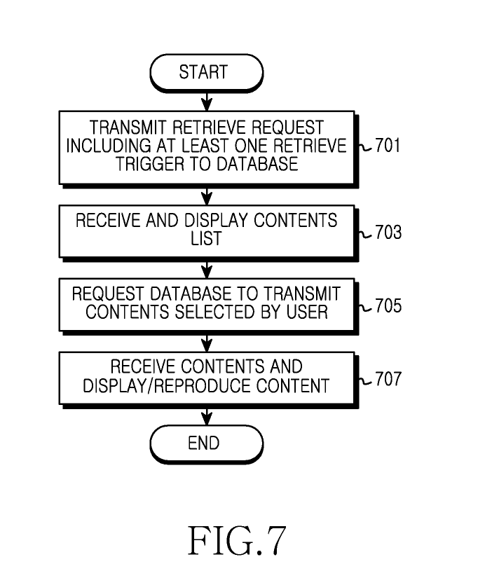

FIG. 7 is a flowchart illustrating a procedure for retrieving content of a computing device according to an embodiment of the present invention.

Referring to FIG. 7, the computing device transmits a retrieve request including a retrieve trigger to a database in Step 701. The retrieve trigger is input or selected by a user. For example, the retrieve trigger may include at least one of a place mark and a comment. Alternatively, the retrieve trigger may include at least one of additional information items tagged to content such as a location, a time, weather, the place mark, the comment, etc. The retrieve request may include identification information of the computing device or the user to appraise a content sharing right of a user of the computing device.

The computing device proceeds to Step 703 to receive a content list related to the retrieve trigger from the database, and display the content list via a display unit. The content list includes content registered by the user of the computing device, and may include content registered by other users. The computing device may sort the content according to at least one of the location, the time, the weather, the place mark, the comment, and a type of content, and display the content list. According to an embodiment of the present invention, the computing device may filter a portion of obtained content, and then display the filtered portion. For example, the filtering may be performed to display content belonging to a category selected in advance, display content of a place existing within a predetermined distance from the computing device, display recently used content, or display content registered as favorite, and display content stored in a folder directly generated by a relevant user. According to another embodiment of the present invention, content that passed through the filtering in the database may be received in Step 703.

After displaying the content list, the computing device proceeds to Step 705 to determine user selection, and transmit a sharing request for content selected by the user to the database. The sharing request may include identification information of the computing device or the user to appraise a content sharing right of a user of the computing device.

The computing device proceeds to Step 707 to receive content from the database, and display or reproduce content of the content. That is, where the content is in text format such as a document, a memo, etc., the computing device displays the text. Where the content is multimedia such as an image, an audio, a moving image, etc., the computing device reproduces the content. According to an embodiment of the present invention, a different operation may be performed depending on a specific form of a place mark. For example, where the selected content is tagged with a place mark of a hyperlink form, the computing device may share a web page indicated by the hyperlink. For another example, where the selected content is tagged with a place mark of an audio form, the computing device may reproduce the audio. For another example, where the selected content is tagged with a place mark of a contact information form, the computing device may display an interface for writing a mail or a character to the contact information, or may try a telephone connection to the contact information. However, according to an embodiment of the present invention, the computing device may not display or reproduce the content but store the content.

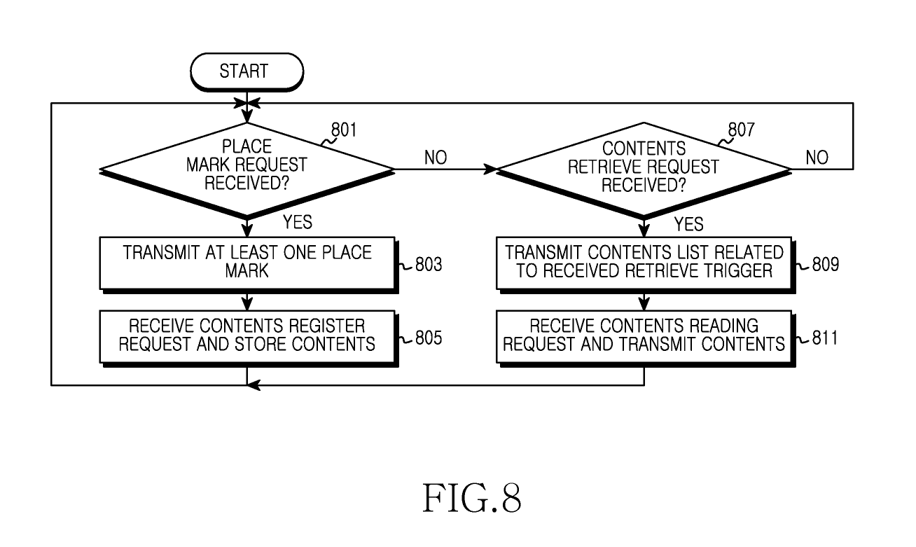

FIG. 8 is a flowchart illustrating a procedure for operating a database according to an embodiment of the present invention.

Referring to FIG. 8, the database determines whether a place mark request is received from a computing device which is UE in Step 801. That is, the database stores and manages a plurality of place marks, and provides a place mark in response to a request from the UE. A company of a relevant place registers the place mark in the database in advance, so that the place mark can be stored in the database. The place mark request may include at least one of location information of the UE, and identification information (for example, a company name, an address, a location, etc.) of a place whose place mark is desired.

When the place mark request is received, the database proceeds to Step 803 to transmit a place mark corresponding to information included in the place mark request to the computing device. For example, where location information of the computing device is included in the place mark request, the database retrieves a place mark of a store located in the neighborhood of the computing device, and transmits a retrieved place mark. Here, being located in the neighborhood means being separated by a distance of less than a predetermined threshold. For another example, where identification information of a place such as a store, etc. is included in the place mark request, the database retrieves a place mark corresponding to the identification information, and transmits a retrieved place mark. According to an embodiment of the present invention, the database may filter a portion of the obtained place mark, and provide only a filtered portion. For example, the filtering may be performed to display place marks belonging to a category selected in advance, display a place mark of a place existing within a predetermined distance from the computing device, display place marks recently used, or display place marks registered as a favorite.

The database proceeds to Step 805 to receive a content register request from the computing device, and stores received content together with the register request. The database may store the place mark inside the content, or store the place mark separately from the content, and generate a tagging list representing a mapping relation between the place mark and the content. Additionally, the register request may include information regarding a sharing right of the content. For example, the information regarding the sharing right may include content of allowing only a specific user or other users classified to a specific group to share content, or not allowing sharing. In addition, though not shown in FIG. 8, a user of the computing device may receive a coupon, points in reward for providing the content. The database may transmit information informing the provided reward.

When the place mark request is not received in Step 801, the database proceeds to Step 807 to determine whether a content retrieve request is received. The content retrieve request includes a retrieve trigger. For example, the retrieve trigger may include at least one of a place mark and a comment. Alternatively, the retrieve trigger may include at least one of additional information items tagged to content such as a location, a time, weather, the place mark, the comment, etc. In addition, the retrieve request may include identification information of the computing device or the user.

When the retrieve request is received, the database proceeds to Step 809 to retrieve content related to the retrieve trigger included in the retrieve request, and transmit a content list including the retrieved content to the computing device. The content list includes content registered by a user of the computing device, and may include content registered by other users. Though not shown in FIG. 8, the computing device may appraise a sharing right for the user of the computing device, and retrieve content related to the retrieve trigger for only shareable content. According to an embodiment of the present invention, the database filters a portion of the obtained content, and then provides a content list including only a filtered portion. For example, the filtering may be performed to display content belonging to a category selected in advance, display content of a place existing within a predetermined distance from the computing device, display recently used content, or display content registered as favorite, and display content stored in a folder directly generated by a relevant user.

The database proceeds to Step 811 to receive a content share request from the computing device, and transmit requested content to the computing device. The share request may include at least one of identification information of the computing device or the user, and identification information of requested content.

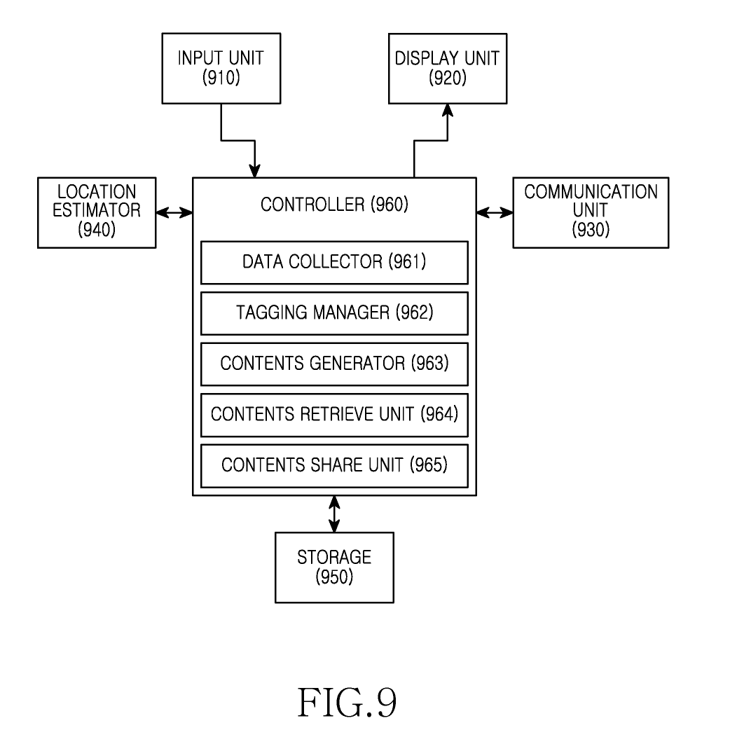

FIG. 9 is a block diagram illustrating a computing device according to an embodiment of the present invention.

As illustrated in FIG. 9, the computing device includes an input unit 910, a display unit 920, a communication unit 930, a location estimator 940, a storage 950, and a controller 960.

The input unit 910 detects an input generated by a user and provides information corresponding to the input to the controller 960. That is, the input unit 910 processes user input via a keyboard, a keypad, a touch screen, a touch pad, a mouse, a special function button, etc. The display unit 920 displays state information that occurs during an operation of the computing device, and numbers, characters, images, etc. by execution of an application program. That is, the display unit 920 displays image data provided from the controller 960 via a visual screen. For example, the display unit 920 may be a Liquid Crystal Display (LCD), an Organic Light-Emitting Diode (OLED), etc.

The communication unit 930 provides a function for communication. For example, the communication unit 930 provides an interface for wireless communication or wired communication. In case of the wired communication, the communication unit 930 includes a modem and a cable connection terminal for mutual conversion between a transmission signal and digital data. In case of wireless communication, the communication unit 930 includes a modem for mutual conversion between an analog signal and digital data, a Radio Frequency (RF) front end for RF processing, and an antenna.

The location estimator 940 estimates a current location of the computing device. For example, the location estimator 940 may estimate a location using signals of a GPS satellite, or estimate a location via the TOA technique, the TDOA technique, etc. using signals of base stations of a mobile communication system. The storage 950 stores a basic program for an operation of the computing device, an application program, and data such as user content, etc. For example, the storage 950 may store content, a place mark, etc. In addition, the storage 950 provides stored data in response to a request of the controller 960.

The controller 960 controls an overall operation of the computing device. More particularly, the controller 960 controls functions of generating content, tagging content, and retrieving content. For this purpose, the controller 960 includes an information collector 961, a tagging manager 962, a content generator 963, a content retrieve unit 964, and a content share unit 965. The data collector 961 collects additional information for tagging such as location information estimated by the location estimator 940, time information, weather information, etc. The tagging manager 962 tags additional information to content based on location information collected by the data collector 961. For example, the tagging manager 962 may tag a location, weather, a time, etc., and may further tag a place mark. The content generator 963 generates content. For example, the content generator 963 may generate multimedia content using a camera, a microphone, etc. provided to the computing device. For another example, the content generator 963 may generate content such as a document, a memo, etc. via execution of an application. The content retrieve unit 964 sorts content according to a personal interest such as a region, a time, weather, details of expenditure, etc. The content share unit 965 processes functions for sharing content via the database, for example, registration of content, request of content, etc. That is, the controller 960 controls a procedure for registering content as illustrated in FIG. 7, and controls a procedure for retrieving content as illustrated in FIG. 7.

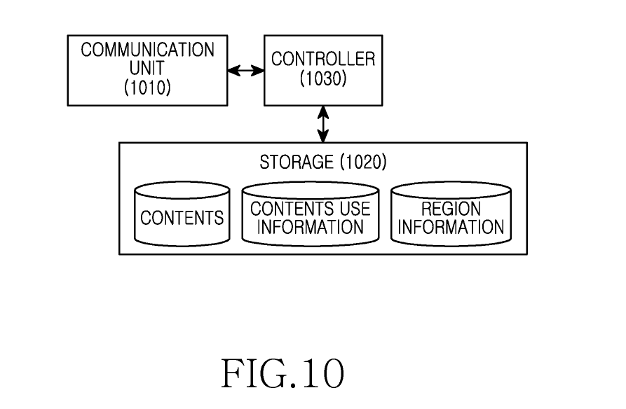

FIG. 10 is a block diagram illustrating a database according to an embodiment of the present invention.

As illustrated in FIG. 10, the database includes a communication unit 1010, a storage 1020, and a controller 1030.

The communication unit 1010 provides a function for communication. For example, the communication unit 930 includes a modem for mutual conversion between a transmission signal and digital data, and a cable connection terminal.

The storage 1020 stores a basic program for an operation of the database, user-registered content, region information, content use information, etc. In addition, the storage 102 provides stored data in response to a request of the controller 1030. The region information is data regarding one region based on collected location information, and includes a place mark. The user-registered content denotes content such as audio, an image, a moving image, text, etc. to which additional information provided by a user has been tagged. The content use information denotes user content sharing history, and expresses a content consume trend.

The controller 1030 controls an overall operation of the database. More particularly, the controller 1030 controls functions of registering content to which additional information has been tagged according to user request, retrieving the content, and providing the content. That is, the controller 1030 controls a procedure of registering content and a procedure of retrieving content as illustrated in FIG. 8.

The present invention allows a computing device to include location information when generating content, and retrieve and sort content according to interest. Generated content allows a user to understand behavior patterns such as visits, expenditures, etc., share content with people in relevant regions, for economic activities such as obtaining a coupon and gaining points.

While the present invention has been shown and described with reference to various embodiments thereof, it will be understood by those skilled in the art that changes in form and detail may be made without departing from the spirit and scope of the present invention as defined by the appended claims.

What is claimed is:

1. A method for operating a computing device, the method comprising:
determining a location of the computing device; and
tagging content with a place mark corresponding to the location.

2. The method of claim 1, further comprising registering the content in a database.

3. The method of claim 1, wherein the place mark represents a place separated by a distance of less than a threshold from the location, and the place mark includes at least one of a company name, a graphic element, a hyperlink, an audio, and contact information.

4. The method of claim 1, further comprising:
displaying a place mark corresponding to the location; and
determining a place mark selected by a user.

5. The method of claim 4, wherein displaying the place mark includes filtering a plurality of place marks to display a portion of the plurality of place marks.

6. The method of claim 5, wherein filtering is performed to display a place mark belonging to a category selected in advance, display a place mark of a place existing within a predetermined distance from the computing device, display recently used place marks , or display place marks registered as favorite.

7. The method of claim 4, wherein the place mark is sorted by at least one of a business field, a category, and a distance from the computing device.

8. The method of claim 4, further comprising:
requesting a database to transmit a place mark; and
receiving the place mark from the database.

9. The method of claim 1, further comprising:
tagging the content, with a comment input by a user.

10. The method of claim 1, further comprising:
tagging the content, with at least one of the location, a time, and weather information.

11. The method of claim 1, wherein tagging the content with the place mark comprises storing the place mark inside the content.

12. The method of claim 1, wherein tagging the content with the place mark comprises:
storing the place mark; and
generating a tagging list representing a mapping relation between the place mark and the content.

13. A method for operating a computing device, the method comprising:
displaying a list of content tagged with a first place mark among content registered in a database;
requesting sharing of content selected by a user from the list of content; and
receiving the content from the database.

14. The method of claim 13, wherein the first place mark includes at least one of a company name, a graphic element, a hyperlink, an audio, and contact information.

15. The method of claim 13, wherein the list of content includes content registered by other users besides a user of the computing device.

16. The method of claim 13, wherein displaying the list of content comprises filtering a plurality of content to display a portion of the plurality of content tagged with the first place mark.

17. The method of claim 16, wherein filtering is performed to display content belonging to a category selected in advance, display content of a place existing within a predetermined distance from the computing device, display recently used content, display content registered as favorite, or display content stored in a folder directly generated by a relevant user.

18. A method for operating a database, the method comprising:
providing a list of content tagged with a first place mark to a first user;
receiving a request to share content from the list of content; and
providing the content to the first user.

19. The method of claim 18, wherein the first place mark includes at least one of a company name, a graphic element, a hyperlink, an audio, and contact information.

20. The method of claim 18, wherein the list of content includes content registered by other users besides the first user.

21. The method of claim 18, wherein providing the list of content comprises:
filtering a plurality of content tagged with the first place mark; and
providing a content list comprising the filtered portion of the content.

22. The method of claim 21, wherein filtering is performed to display content belonging to a category selected in advance, display content of a place existing within a predetermined distance from the computing device, display recently used content, display content registered as favorite, or display content stored in a folder directly generated by a relevant user.

23. The method of claim 18, further comprising:
receiving a request by a second user to provide a place mark; and
providing the requested place mark to the second user.

24. The method of claim 23, wherein the place mark includes a place separated by a distance of less than a threshold from a location of the second user.

25. The method of claim 23, wherein providing the place mark comprises:
filtering a plurality of place marks; and
providing the filtered portion of the place marks.

26. The method of claim 25, wherein filtering is performed to display a place mark belonging to a category selected in advance, display a place mark of a place existing within a predetermined distance from the computing device, display place marks recently used, or display place marks registered as favorite.

27. A computing device, the computing device comprising:
a location estimator configured to determine a location of the computing device; and
a controller configured to tag content with a place mark corresponding to the location.

28. The device of claim 27, wherein the controller further configured to register the content in a database.

29. The device of claim 27, wherein the place mark represents a place separated by a distance of less than a threshold from the location, and the place mark includes at least one of a company name, a graphic element, a hyperlink, an audio, and contact information.

30. The device of claim 27, further comprising:
a display unit configured to display the place mark corresponding to the location, wherein the controller further configured to determine a place mark selected by a user.

31. The device of claim 30, wherein the controller further configured to filter a plurality of place marks and displays a portion of the plurality of place marks.

32. The device of claim 31, wherein filtering is performed to display a place mark belonging to a category selected in advance, display a place mark of a place existing within a predetermined distance from the computing device, display recently used place marks, or display place marks registered as favorite.

33. The device of claim 30, wherein the place mark is sorted and displayed using at least one of a business field, a category, and a distance from the computing device.

34. The device of claim 27, wherein the controller further configured to request a database to transmit a place mark and receive a place mark from the database.

35. The device of claim 27, wherein the controller further configured to tag a comment input by a user to the content.

36. The device of claim 27, wherein the controller tags at least one of the location, a time, and weather information to the content.

37. The device of claim 27, wherein the controller further configured to store the place mark inside the content in order to tag the place mark to the content.

38. The device of claim 27, wherein the controller further configured to, in order to tag the place mark to the content, store the place mark and generate a tagging list representing a mapping relation between the place mark and the content.

39. A computing device comprising:
a display unit configured to display a list of content tagged with a first place mark among content registered in a database;
a controller configured to request sharing of content selected by a user from the list of content; and
a communication unit configured to receive the content from the database.

40. The device of claim 39, wherein the first place mark includes at least one of a company name, a graphic element, a hyperlink, an audio, and contact information.

41. The device of claim 39, wherein the list of content includes content registered by other users besides a user of the computing device.

42. The device of claim 39, wherein the controller further configured to filter a plurality of content tagged with the first place mark and displays a portion of the plurality of content.

43. The device of claim 42, wherein filtering is performed to display content belonging to a category selected in advance, display content of a place existing within a predetermined distance from the computing device, display recently used content, display content registered as favorite, or display content stored in a folder directly generated by a relevant user.

44. A database unit, the database unit comprising:
a storage configured to store content registered by a user;
a controller configured to provide a list of content tagged with a first place mark to a first user; and
a communication unit configured to receive a request to share content from the list of content and provide the content to the first user.

45. The database unit of claim 44, wherein the first place mark includes at least one of a company name, a graphic element, a hyperlink, an audio, and contact information.

46. The database unit of claim 44, wherein the list of content includes content registered by other users besides the first user.

47. The database unit of claim 44, wherein the controller further configured to filter a plurality of content tagged with the first place mark, and provides a content list comprising the filtered portion of the content.

48. The database unit of claim 47, wherein filtering is performed to display content belonging to a category selected in advance, display content of a place existing within a predetermined distance from the computing device, display recently used content, display content registered as favorite, or display content stored in a folder directly generated by a relevant user.

49. The database unit of claim 44, wherein the controller further configured to be requested by a second user to provide a place mark, and provides a place mark to the second user.

50. The database unit of claim 49, wherein the place mark includes a place separated by a distance of less than a threshold from a location of the second user.

51. The database unit of claim 49, wherein the controller further configured to filter a plurality of place marks, and provides the filtered portion of the place marks.

52. The database unit of claim 51, wherein filtering is performed to display a place mark belonging to a category selected in advance, display a place mark of a place existing within a predetermined distance from the computing device, display recently used place marks, or display place marks registered as favorite.

53. A method for operating a computing device, the method comprising:
determining a location of the computing device using a Global Positioning System (GPS);
transmitting the location to a database;
receiving a place mark corresponding to the location from the database; and
tagging content with at least one of a place mark corresponding to the location, the location, a time, and weather information.

54. A method for operating a computing device, the method comprising:
requesting a database to transmit a list of content tagged with a first place mark;
receiving the list of content from the database;
displaying the list of content;
requesting the database to transmit content selected by a user from the list of content; and
receiving the content from the database.

55. A method for operating a database, the method comprising:
receiving a retrieve request of content tagged with a first place mark from a first user;
retrieving content tagged with the first place mark among user registered content;
providing a list of content tagged with the first place mark to the first user;
receiving a request to share content from the list of content; and
providing the content to the first user.
